(19) United States
(12) Patent Application Publication
(10) Pub. No.: US 2020/0141495 A1
(43) Pub. Date: May 7, 2020

(54) HOUSING OF IN-VEHICLE APPARATUS

(71) Applicant: HITACHI AUTOMOTIVE SYSTEMS, LTD., Hitachinaka-shi, Ibaraki (JP)

(72) Inventors: Norihiro KIMURA, Atsugi-shi, Kanagawa (JP); Osamu YOSHIDA, Yokohama-shi, Kanagawa (JP)

(73) Assignee: HITACHI AUTOMOTIVE SYSTEMS, LTD., Hitachinaka-shi, Ibaraki (JP)

(21) Appl. No.: 16/624,172

(22) PCT Filed: Jun. 5, 2018
(86) PCT No.: PCT/JP2018/021513

§ 371 Date: Dec. 18, 2019

(30) Foreign Application Priority Data
Jun. 22, 2017 (JP) 2017-121825

(51) Int. Cl. F16J 15/14; F16H 57/029

(52) U.S. Cl. CPC F16J 15/14; B62D 1/16; F16H 57/029

(57) ABSTRACT

The present invention provides a housing of an in-vehicle apparatus capable of further improving sealability of joint surfaces. A housing for an in-vehicle apparatus includes a first sealant holding portion, a second sealant holding portion, and a liquid sealant provided in the first sealant holding portion and the second sealant holding portion. The first sealant holding portion is a recessed groove opened to one of a first joint surface and a second joint surface. The first sealant holding portion is disposed at an intermediate portion in a thickness direction of a first housing member. The second sealant holding portion is a recessed portion opened to the first joint surface. The second sealant holding portion is disposed on a first inner surface side with respect to the first sealant holding portion in the thickness direction of the first housing member. The second sealant holding portion forms a recessed portion for holding the sealant between the second sealant holding portion and the second joint surface with the first joint surface and the second joint surface in abutment with each other.

### TECHNICAL FIELD

The present invention relates to a housing of an in-vehicle apparatus.

### BACKGROUND ART

PTL 1 discloses a housing of an in-vehicle apparatus in which a first member and a second member are joined to each other via a liquid gasket on joint surfaces. A first chamfered portion and a second chamfered portion are formed on inner end portions of the joint surfaces of the first member and the second member. The first chamfered portion and the second chamfered portion are used to hold the liquid gasket protruding beyond the joint surfaces when the first member and the second member are fastened to each other, thereby allowing it to function as a seal portion.

### CITATION LIST

### Patent Literature

[PTL 1] Japanese Patent Application Public Disclosure No. 2016-130555

### SUMMARY OF INVENTION

### Technical Problem

However, the above-described conventional technique has a problem of its low sealability for the joint surfaces due to the provision of the seal portion only at the inner end portions of the joint surfaces.

One of objects of the present invention is to provide a housing of an in-vehicle apparatus capable of improving the sealability of the joint surfaces.

### Solution to Problem

A housing for an in-vehicle apparatus according to one aspect of the present invention includes a first sealant holding portion, a second sealant holding portion, and a liquid sealant provided in the first sealant holding portion and the second sealant holding portion. The first sealant holding portion is a recessed groove opened to one of a first joint surface and a second joint surface. The first sealant holding portion is disposed at an intermediate portion in a thickness direction of a first housing member. The second sealant holding portion is a recessed portion opened to the first joint surface. The second sealant holding portion is disposed on a first inner surface side with respect to the first sealant holding portion in the thickness direction of the first housing member. The second sealant holding portion forms a recessed portion for holding the sealant between the second sealant holding portion and the second joint surface with the first joint surface and the second joint surface in abutment with each other.

Therefore, the housing for the in-vehicle apparatus according to the one aspect of the present invention can improve the sealability of the joint surfaces.

### BRIEF DESCRIPTION OF DRAWINGS

FIG. 1 is a front view of a power steering apparatus 1 according to a first embodiment.

FIG. 2 is an exploded perspective view of a gear housing 4 according to the first embodiment.

FIG. 3 is an axial cross-sectional view of the gear housing 4.

FIG. 4 is an enlarged view of main portions illustrated in FIG. 3.

FIG. 5 illustrates a first housing member 8 as viewed from an X-axis positive direction side.

FIG. 6 is an enlarged view of main portions of the first housing member 8 immediately before a first joint surface 11 is machined.

FIG. 7 is an enlarged view of the main portions in FIG. 3 that illustrates another embodiment.

FIG. 8 is an enlarged view of the main portions in FIG. 3 that illustrates another embodiment.

FIG. 9 is an enlarged view of the main portions in FIG. 3 that illustrates another embodiment.

### DESCRIPTION OF EMBODIMENTS

### First Embodiment

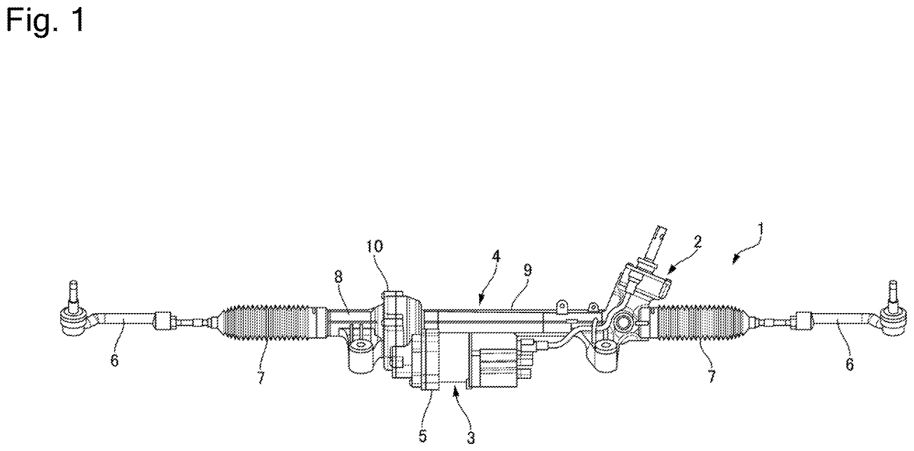

FIG. 1 is a front view of a power steering apparatus 1 according to a first embodiment.

The power steering apparatus 1 is an in-vehicle apparatus mounted on a vehicle that uses an engine as a power source thereof. The power steering apparatus 1 includes a steering mechanism 2, an electric motor 3, a gear housing (a housing) 4, and a motor housing 5.

The steering mechanism 2 converts a rotational motion of a not-illustrated steering wheel into linear motions of a pair of tie rods 6 and 6. Not-illustrated front wheels are connected to the pair of tie rods 6 and 6, respectively. The electric motor 3 provides a steering force to the steering mechanism 2. The electric motor 3 is, for example, a three-phase brushless motor. An output of the electric motor 3 is controlled by a not-illustrated motor control unit according to a driver's steering torque input to the steering wheel and/or a vehicle speed.

The gear housing 4 is disposed in such a manner that an axial direction thereof extends along a vehicle width direction. The gear housing 4 is formed by casting with use of an aluminum alloy. The gear housing 4 houses a part of the steering mechanism 2, a not-illustrated rack bar and ball screw mechanism therein. The ball screw mechanism converts a rotational force of the electric motor 3 into a thrust force of the rack bar. The motor housing 5 is formed by casting with use of an aluminum alloy. The motor housing 5 houses the electric motor 3 therein. The motor housing 5 is fixed to the gear housing 4. One axial end sides of dust boots 7 are fixed to both axial ends of the gear housing 4, respectively. The dust boots 7 are each formed into a bellows-like annular shape with use of synthetic resin or the like. Other axial end sides of the dust boots 7 are fixed to the tie rods 6, respectively.

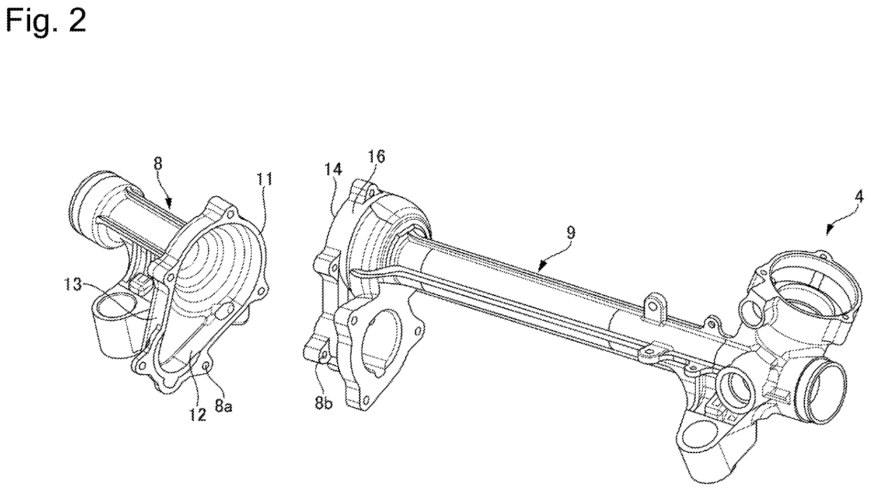

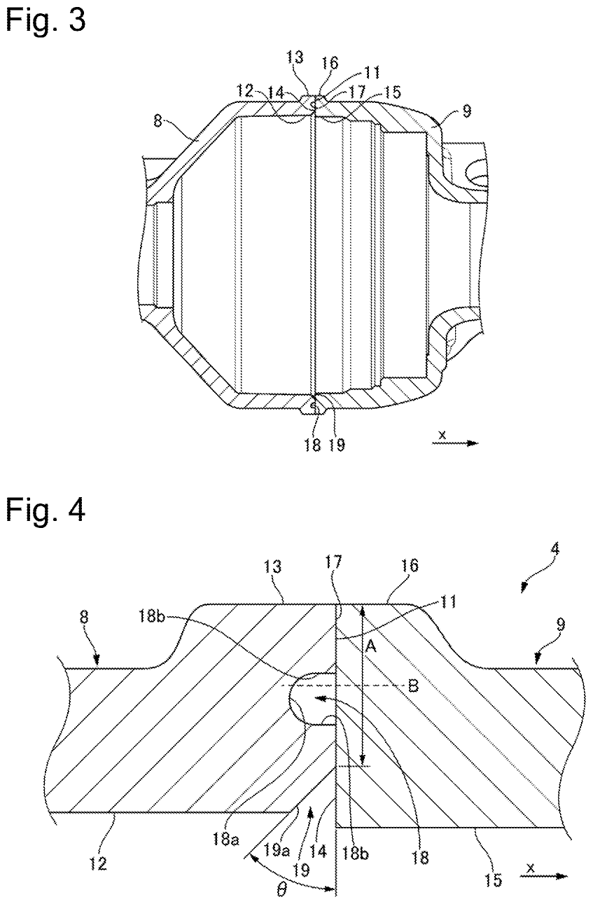

FIG. 2 is an exploded perspective view of the gear housing 4 according to the first embodiment. FIG. 3 is an axial cross-sectional view of the gear housing 4. The gear housing 4 has a bisection structure, in which a first housing member 8 and a second housing member 9 are jointed in abutment with each other in the axial direction of the gear housing 4. Hereinafter, an X axis is set to the axial direction of the gear housing 4, and a direction extending from the first housing member 8 toward the second housing member 9 side is defined to be an X-axis positive direction. Further, a direction around the X axis, and a direction extending perpendicularly to the X axis and extending from an inner side toward an outer side of the gear housing 4 are defined to be a circumferential direction and a thickness direction, respectively. In the gear housing 4, an inner space containing a part of the rack bar and the ball screw mechanism therein is formed inside the position at which the first housing member 8 and the second housing member 9 are in abutment with each other.

The first housing member 8 and the second housing member 9 are fastened together with use of five bolts/nuts (a coupling member) 10. The first housing member 8 includes five first bolt insertion holes (a first coupling member insertion hole) 8a penetrating in the X-axis direction, on an outer side in the thickness direction of the position thereof in abutment with the second housing member 9. The individual first bolt insertion holes 8a are disposed so as to be spaced apart from each other in the circumferential direction. The second housing member 9 includes five second bolt insertion holes (a second coupling member insertion hole) 9a penetrating in the X-axis direction, on an outer side in the thickness direction of the position thereof in abutment with the first housing member 8. The individual second bolt insertion holes 9a are disposed so as to be spaced apart from each other at positions corresponding to the individual first bolt insertion holes 8a in the circumferential direction. The bolts of the bolts/nuts 10 penetrate through the first bolt insertion holes 8a and the second bolt insertion holes 9a.

The first housing member 8 includes a first joint surface 11, a first inner surface 12, and a first outer surface 13. The first joint surface 11 extends in the thickness direction. The first joint surface 11 is formed by machining, and a surface roughness thereof is set to 6.4 [μm] or lower in terms of an arithmetic average roughness Ra. The first inner surface 12 extends from an end of an inclined surface 19a in the X-axis negative direction toward the X-axis negative direction side. The inclined surface 19a, which will be described below, is formed on an inner end of the first joint surface 11 in the thickness direction. The first outer surface 13 extends from an outer end of the first joint surface 11 in the thickness direction toward the X-axis negative direction side.

The second housing member 9 includes a second joint surface 14, a second inner surface 15, and a second outer surface 16. The second joint surface 14 extends in the thickness direction. The first housing member 8 and the second housing member 9 are coupled with each other with the second joint surface 14 in abutment with the first joint surface 11. The second joint surface 14 is formed by machining, and a surface roughness thereof is set to 6.4 [μm] or lower in terms of the arithmetic average roughness Ra. A liquid sealant 17, which is a liquid gasket, is applied to between the first joint surface 11 and the second joint surface 14. The second inner surface 15 extends from an inner end of the second joint surface 14 in the thickness direction toward the X-axis positive direction side. A position of the second inner surface 15 in the thickness direction is in alignment with the first inner surface 12. The second outer surface 16 extends from an outer end of the second joint surface 14 in the thickness direction toward the X-axis positive direction side. A position of the second outer surface 16 in the thickness direction is in alignment with the first outer surface 13.

The first embodiment is configured in such a manner that the gear housing 4 includes a first sealant holding portion 18 and a second sealant holding portion 19 holding the liquid sealant 17 with the aim of increasing sealability of the joint surfaces of the first housing member 8 and the second housing member 9. In the following description, the first sealant holding portion 18 and the second sealant holding portion 19 will be described in detail.

FIG. 4 is an enlarged view of main portions illustrated in FIG. 3.

The first sealant holding portion 18 is a recessed groove formed on the first joint surface 11. The first sealant holding portion 18 is disposed at an intermediate portion of the first housing member 8 in the thickness direction. More specifically, in the thickness direction, the first sealant holding portion 18 is disposed on an inner side with respect to a central portion B of a region A not including the second sealant holding portion 19. The intermediate portion includes not only a central portion at a bisection position but also any position except for an inner end and an outer end.

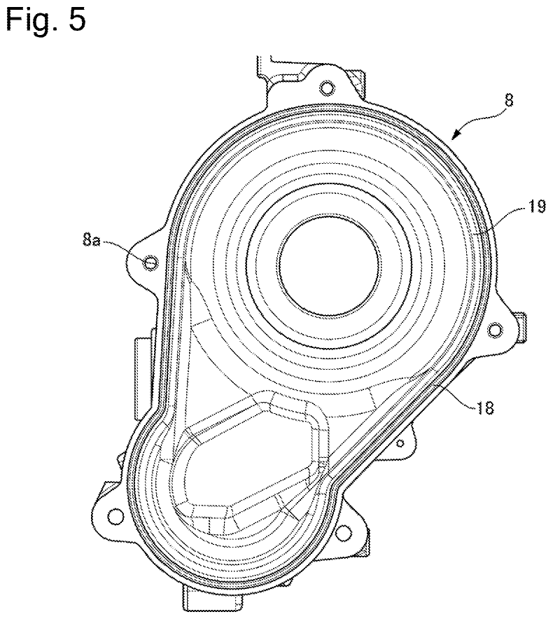

The first sealant holding portion 18 includes a bottom surface 18a and a pair of side wall surfaces 18b and 18b. The bottom surface 18a faces the second joint surface 14, and has a recessed circular-arc shape opened toward the X-axis positive direction side (the second joint surface 14 side). The pair of side wall surfaces 18b and 18b is provided on both sides of the bottom surface 18a in the thickness direction, and faces each other. The pair of side wall surfaces 18b and 18b extends in the X-axis direction to connect the bottom surface 18a and the first joint surface 11 to each other. FIG. 5 illustrates the first housing member 8 as viewed from the X-axis positive direction side. The first sealant holding portion 18 is annularly continuous as viewed from the X-axis direction, and is disposed on an inner side with respect to each of the first bolt insertion holes 8a in the thickness direction. The same also applies to the second sealant holding portion 19. The inclined surface 19a is annularly continuous as viewed from the X-axis direction, and is disposed on an inner side with respect to the first sealant holding portion 18 in the thickness direction.

The second sealant holding portion 19 is a recessed portion provided on the inner end of the first joint surface 11 in the thickness direction. The second sealant holding portion 19 is formed between the inclined surface 19a formed on the first joint surface 11 and the second joint surface 14. The inclined surface 19a is formed on the inner end of the first joint surface 11 in the thickness direction. The inclined surface 19a is inclined toward the X-axis negative direction side from the outer side to the inner side in the thickness direction. A minor angle among angles defined between the inclined surface 19a and the thickness direction is set to 30 degrees or wider and narrower than 45 degrees.

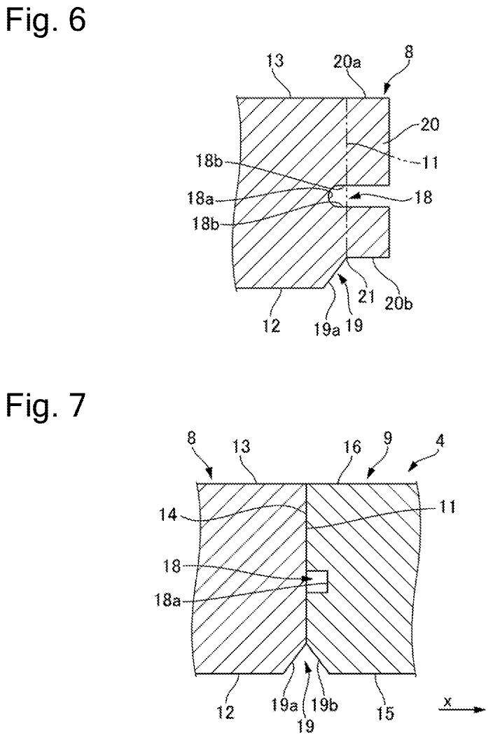

FIG. 6 is an enlarged view of the main portions of the first housing member 8 immediately before the first joint surface 11 is machined. The first housing member 8 formed by casting and not yet machined includes a dimensional adjustment portion 20. The dimensional adjustment portion 20 is provided on the X-axis positive direction side with respect to the second sealant holding portion 19 in the X-axis direction. A position of an outer surface 20a of the dimensional adjustment portion 20 in the thickness direction is in alignment with the first outer surface 13. A position of an inner surface 20b of the dimensional adjustment portion 20 in the thickness direction is in alignment with the end of the second sealant holding portion 19 in the X-axis positive direction. A bent portion 21 is formed between the second sealant holding portion 19 and the dimensional adjustment portion 20. An end of the dimensional adjustment portion 20 in the X-axis negative direction is cut along the thickness direction by the machining, and this machined surface becomes the first joint surface 11. The first sealant holding portion 18 (the bottom surface 18a and the pair of side wall surfaces 18b and 18b thereof) and the second sealant holding portion 19 (the inclined surface 19a thereof) are not machined, and therefore have casting surfaces (mill scale surfaces) on the surfaces thereof.

Next, advantageous effects of the first embodiment will be described.

The gear housing 4 according to the first embodiment includes the first sealant holding portion 18 and the second sealant holding portion 19 in the thickness direction of the first housing member 8 and the second housing member 9 on the joint surfaces of the first housing member 8 and the second housing member 9.

When the gear housing 4 is assembled, the first housing member 8 and the second housing member 9 are fastened together with use of the bolts/nuts 10 after the liquid sealant 17 is applied onto one of the first joint surface 11 and the second joint surface 14. When a fastening pressure is applied to between the first joint surface 11 and the second joint surface 14, a part of the liquid sealant 17 flows to the first sealant holding portion 18 and the second sealant holding portion 19 to fill the insides thereof, and then is brought into a cured state after that. The liquid sealant cured inside the first sealant holding portion 18 and the second sealant holding portion 19 function as double seal portions for the joint surfaces. As a result, the gear housing 4 can improve the sealability of the joint surfaces compared to the conventional housing including the seal portion only at the inner end portions of the joint surfaces.

The second sealant holding portion 19 is provided at the end portion on the same side as the first inner surface 12 in the thickness direction of the first housing member 8. One of the double seal portions is disposed at the inner end portion in the thickness direction of the first housing member 8, which eliminates the necessity of preparing a region in abutment with the second joint surface 14 on the inner side with respect to the second sealant holding portion 19 in the thickness direction. Therefore, the gear housing 4 can reduce the dimension of the first housing member 8 in the thickness direction. Further, the second sealant holding portion 19 is exposed to the inner surface of the gear housing 4, and the exposure thereof on the inner side of the gear housing 4 makes it less likely for an assembler to mistakenly touch the liquid sealant 17 in the second sealant holding portion 19. Therefore, the gear housing 4 can reduce a risk of deteriorating the sealability due to detachment of the liquid sealant 17.

The second sealant holding portion 19 includes the inclined surface 19a where the dimension of the first housing member 8 in the thickness direction of the first housing member 8 gradually reduces from the end portion of the second sealant holding portion 19 on the opposite side from the second housing member 9 (the X-axis negative direction side) toward the end portion of the second sealant holding portion 19 on the same side as the second housing member 9 (the X-axis positive direction side) in the direction perpendicular to the first joint surface 11 (the X-axis direction). Now, hypothetically supposing that the sealant holding portion has a corner portion, a space failing to be filled with the liquid sealant 17 might be generated at this corner portion in this case. On the other hand, the second sealant holding portion 19 according to the first embodiment has no corner portion, and therefore the gear housing 4 can improve a filling performance of the liquid sealant 17 in the second sealant holding portion 19.

The first housing member 8 includes the dimensional adjustment portion 20. The dimensional adjustment portion 20 is provided on the same side as the second housing member 9 with respect to the second sealant holding portion 19 in the direction perpendicular to the first joint surface 11. The position of the end portion of the dimensional adjustment portion 20 on the same side as the first inner surface 12 in the thickness direction of the first housing member 8 coincides with the end portion of the second sealant holding portion 19 on the same side as the second housing member 9. The first joint surface 11 is provided at the end portion on the same side as the first housing member 8 in the direction perpendicular to the first joint surface 11. The first joint surface 11 includes the machined surface cut by the machining.

In the case where the first housing member 8 and the second housing member 9 are formed by the casting, generally, a cast item is low in dimensional accuracy and is also not high in surface accuracy (flatness) as the joint surface. Therefore, providing the dimensional adjustment portion 20 and cutting this dimensional adjustment portion 20 by the machining allows the gear housing 4 to acquire required dimensional accuracy and surface accuracy as the joint surface, thereby improving the dimensional accuracy of the first housing member 8. Further, because a cut amount in a size adjustment varies depending on each product, cutting as far as the second sealant holding portion 19 when the cutting amount is large may lead to insufficiency of the space filled with the liquid sealant 17, thereby resulting in insufficiency of a filling amount of the liquid sealant 17 as a result thereof. Therefore, providing the dimensional adjustment portion 20 separately from the second sealant holding portion 19 can prevent the insufficiency of the filling amount of the liquid sealant 17 in the second sealant holding portion 19.

The first housing member 8 includes the bent portion 21 between the second sealant holding portion 19 and the dimensional adjustment portion 20 in the direction perpendicular to the first joint surface 11. The presence of this bent portion 21 makes a boundary between the second sealant holding portion 19 and the dimensional adjustment portion 20 clear, thereby facilitating confirmation about whether the dimensional adjustment portion 20 remains after the machining, i.e., the cutting does not proceed to as far as the second sealant holding portion 19.

The first sealant holding portion 18 is provided on the first inner surface side 12 with respect to the central portion B in the region A not including the second sealant holding portion 19 in the thickness direction of the first housing member 8. As a result, compared to when the first sealant holding portion 18 is provided on the first outer surface 13 side with respect to the central portion B, the gear housing 4 can reduce an amount by which the liquid sealant 17 filling around the first sealant holding portion 18 protrudes toward the first outer surface 13 side. Protrusion of the liquid sealant 17 toward the first inner surface 12 side, if any, does not especially raise a problem as described above.

The minor angle θ among the angles defined between the second sealant holding portion 19 and the direction perpendicular to the first joint surface 11 is 30 degrees or wider and narrower than 45 degrees. Now, if 8 is narrower than 30 degrees, the second sealant holding portion 19 has a small inner space, and therefore the filling performance of the liquid sealant 17 is deteriorated. On the other hand, if e is 45 degrees or wider, the inclined surface 19a and the second joint surface 14 are spaced apart by an excessively long distance, and therefore adhesiveness of the liquid sealant 17 may be deteriorated. Therefore, setting 8 to 30 degrees or wider and narrower than 45 degrees allows the gear housing 4 to maintain both the filling performance and the adhesiveness of the liquid sealant 17.

The first housing member 8 and the second housing member 9 are the cast items formed by the casting, and the first sealant holding portion 18 and the second sealant holding portion 19 have the casting surfaces on at least a part of the surfaces. The casing surface has rough portions, and has a larger surface area compared to a flat surface shape. Therefore, the gear housing 4 can improve the adhesiveness of the liquid sealant 17 in the first sealant holding portion 18 and the second sealant holding portion 19.

The first outer surface 13 is shaped in such a manner that the end portion thereof on the same side as the second outer surface 16 in the direction perpendicular to the first joint surface 11 is located adjacent to the end portion of the second outer surface 16 on the same side as the first outer surface 13. In other words, the gear housing 4 is structured in such a manner that the first outer surface 13 and the second outer surface 16 are located adjacent to each other and no recessed portion is formed at the joint portion at the outer end of the gear housing 4 in the thickness direction. By being structured in this manner, the gear housing 4 can reduce an amount of the liquid sealant 17 that would adhere to this portion. As a result, the gear housing 4 can reduce inconvenience when the assembler mistakenly touches the liquid sealant 17 adhering to the outer side of the gear housing 4. The term “inconvenience” used herein refers to, for example, contamination of the outer surface of the gear housing 4 or a clothing of the assembler with the liquid sealant 17. Further, this configuration impedes retention of water or the like in the joint portion at the outer end of the gear housing 4 in the thickness direction, thereby being able to prevent the water or the like from entering inside the gear housing 4.

The first sealant holding portion 18 includes the bottom surface 18a facing the second joint surface 14 in the direction perpendicular to the first joint surface 11, and the pair of side wall surfaces 18b and 18b provided on the both sides of the bottom surface 18a in the thickness direction of the first housing member 8 and facing each other. The bottom surface 18a has the recessed circular-arc shape opened toward the second joint surface side. In the case where the first housing member 8 is formed by the casting, a portion of a casting mold that is intended to form the first sealant holding portion 18 has a protruding shape. At this time, in the case where the bottom surface 18a has the recessed circular-arc shape, a tip portion of the protruding shape of the casting mold has an outwardly protruding circular-arc shape, and absence of a corner portion at the tip portion contributes to prolonging the lifetime of the mold.

The surface roughnesses of the first joint surface 11 and the second joint surface 14 are set to 6.4 [μm] or lower in terms of the arithmetic average roughness Ra. Due to this setting, the gear housing 4 can reduce energy exerted to detach the first joint surface and the second joint surface 14, and the liquid sealant 17. As a result, the gear housing 4 can enhance the adhesiveness between the first joint surface 11 and the second joint surface 14, and the liquid sealant 17.

The first sealant holding portion 18 and the second sealant holding portion 19 are annularly continuous. In other words, due to absence of an interrupted gap on the way of the first sealant holding portion 18 and the second sealant holding portion 19 when the joint surfaces are viewed from the circumferential direction, the gear housing 4 can ensure high sealability as the entire gear housing 4.

The gear housing 4 includes the bolts/nuts 10. The bolts/nuts 10 function to couple the first housing member 8 and the second housing member 9 with each other. The first housing member 8 includes the first bolt insertion holes 8a penetrating through in the direction perpendicular to the first joint surface 11, in which the bolts are inserted. The second housing member 9 includes the second bolt insertion holes 9a penetrating through in the direction perpendicular to the first joint surface 11, in which the bolts are inserted. The first sealant holding portion 18 is provided on the first inner surface 12 side with respect to the first bolt insertion holes 8a. Due to this layout, the gear housing 4 can prevent the entry of water or the like from the first bolt insertion holes 8a and the second bolt insertion holes 9a with the aid of the first sealant holding portion 18.

### Other Embodiments

Having described the embodiment for implementing the present invention, the specific configuration of the present invention is not limited to the configuration of the embodiment, and the present invention also includes a design modification and the like thereof made within a range that does not depart from the spirit of the present invention. Further, the individual components described in the claims and the specification can be arbitrarily combined or omitted within a range that allows them to remain capable of achieving at least a part of the above-described objects or producing at least a part of the above-described advantageous effects.

As illustrated in FIGS. 7 and 9, the first sealant holding portion 18 may be provided on the second joint surface 14. Further, the bottom surface 18a of the first sealant holding portion 18 may be formed into a recessed rectangular shape.

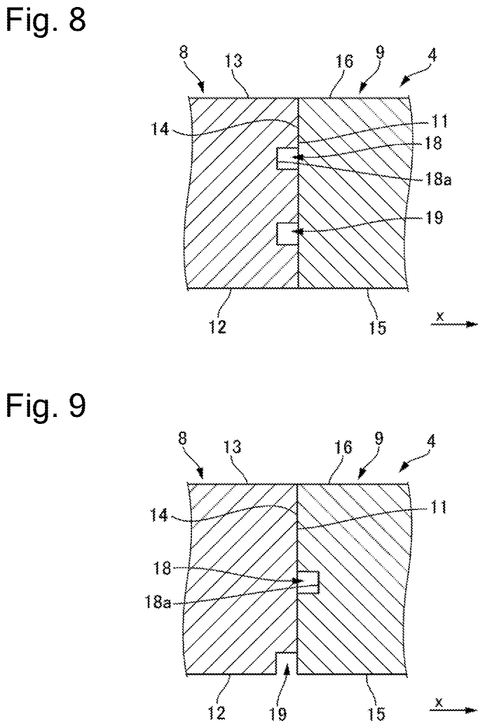

As illustrated in FIG. 7, the inclined surface 19b may be formed at the inner end of the second joint surface 14 in the thickness direction. Further, as illustrated in FIG. 8, the second sealant holding portion 19 may be provided on an outer side with respect to the inner end of the first joint surface 11 in the thickness direction.

As illustrated in FIGS. 8 and 9, the second sealant holding portion 19 may be formed as a rectangular recessed portion.

The coupling member is not limited to the bolts/nuts, and, for example, a screw may be used as it.

The present invention is applicable to not only the gear housing of the power steering apparatus but also a housing of another in-vehicle apparatus, and can bring about advantageous effects similar to the embodiment.

In the following description, other configurations recognizable from the above-described embodiment will be described.

A housing for an in-vehicle apparatus, in one configuration thereof, includes a first housing member including a first joint surface, a first inner surface provided on one side with respect to the first joint surface, and a first outer surface on an opposite side of the first joint surface from the first inner surface, and a second housing member including a second joint surface, a second inner surface, and a second outer surface. The first housing member and the second housing member are coupled with each other with the first joint surface and the second joint surface in abutment with each other on the second joint surface. The second inner surface is provided on the same side as the first inner surface with respect to the second joint surface with the first joint surface and the second joint surface in abutment with each other. The second outer surface is provided on the same side as the first outer surface with respect to the second joint surface with the first joint surface and the second joint surface in abutment with each other. The second housing member forms a space facing the first inner surface and the second inner surface together with the first housing member with the first joint surface and the second joint surface in abutment with each other. The housing further includes a first sealant holding portion, a second sealant holding portion, and a liquid sealant provided in the first sealant holding portion and the second sealant holding portion. The first sealant holding portion is a recessed groove opened to one of the first joint surface and the second joint surface. The first sealant holding portion is disposed at an intermediate portion in a thickness direction of the first housing member. The second sealant holding portion is a recessed portion opened to the first joint surface. The second sealant holding portion is disposed on the first inner surface side with respect to the first sealant holding portion in the thickness direction of the first housing member. The second sealant holding portion forms a recessed portion for holding the sealant between the second sealant holding portion and the second joint surface with the first joint surface and the second joint surface in abutment with each other. The thickness direction of the first housing member is a direction extending from the first inner surface toward the first outer surface on the first joint surface.

According to a further preferable configuration, in the above-described configuration, the second sealant holding portion is provided at an end portion on the same side as the first inner surface in the thickness direction of the first housing member.

According to another preferable configuration, in any of the above-described configurations, the second sealant holding portion has such an inclined shape that a dimension of the first housing member in the thickness direction of the first housing member gradually reduces from an end portion of the second sealant holding portion on an opposite side from the second housing member toward an end portion of the second sealant holding portion on the same side as the second housing member in a direction perpendicular to the first joint surface.

According to further another preferable configuration, in any of the above-described configurations, the first housing member includes a dimensional adjustment portion. The dimensional adjustment portion is provided on the same side as the second housing member with respect to the second sealant holding portion in the direction perpendicular to the first joint surface. An end portion of the dimensional adjustment portion on the same side as the first inner surface in the thickness direction of the first housing member is located at the same position as an end portion of the second sealant holding portion on the same side as the second housing member or on the same side as the first outer surface with respect to this end portion. The first joint surface is provided on an end portion on the same side as the first housing member in the direction perpendicular to the first joint surface. The first joint surface has a machined surface cut by machining.

According to further another preferable configuration, in any of the above-described configurations, the first housing member includes a bent portion between the second sealant holding portion and the dimensional adjustment portion in the direction perpendicular to the first joint surface.

According to further another preferable configuration, in any of the above-described configurations, the first sealant holding portion is provided at a central portion in a region not including the second sealant holding portion or on the first inner surface side with respect to the central portion in the thickness direction of the first housing member.

According to further another preferable configuration, in any of the above-described configurations, the second sealant holding portion is provided in such a manner that a minor angle among angles defined between an inclined surface of the second sealant holding portion and the direction perpendicular to the first joint surface is 30 degrees or wider and narrower than 45 degrees.

According to further another preferable configuration, in any of the above-described configurations, the first housing member and the second housing member are cast items formed by casting. The first sealant holding portion or the second sealant holding portion has a casting surface at least on a part of a surface thereof.

According to further another preferable configuration, in any of the above-described configurations, the first outer surface is shaped in such a manner that an end portion thereof on the same side as the second outer surface in the direction perpendicular to the first joint surface is located adjacent to an end portion of the second outer surface on the same side as the first outer surface.

According to further another preferable configuration, in any of the above-described configurations, the first sealant holding portion includes a bottom surface facing the second joint surface in a direction perpendicular to the first joint surface, and a pair of side wall surfaces provided on both sides of the bottom surface in the thickness direction of the first housing member and facing opposite from each other. The bottom surface has a recessed circular-arc shape opened toward the second joint surface side.

According to further another preferable configuration, in any of the above-described configurations, an arithmetic average roughness Ra of each of the first joint surface and the second joint surface is 6.4 [μm] or lower.

According to further another preferable configuration, in any of the above-described configurations, the first sealant holding portion is annularly continuous.

According to further another preferable configuration, any of the above-described configurations further includes a coupling member configured to couple the first housing member and the second housing member with each other. The first housing member includes a first coupling member insertion hole penetrating through in a direction perpendicular to the first joint surface. The coupling member is inserted in the first coupling member insertion hole. The second housing member includes a second coupling member insertion hole penetrating through in the direction perpendicular to the first joint surface. The coupling member is inserted in the second coupling member insertion hole. The first sealant holding portion is provided on the first inner surface side with respect to the first coupling member insertion hole.

The present application claims priority under the Paris Convention to Japanese Patent Application No. 2017-121825 filed on Jun. 22, 2017. The entire disclosure of Japanese Patent Application No. 2017-121825 filed on Jun. 22, 2017 including the specification, the claims, the drawings, and the abstract is incorporated herein by reference in its entirety.

### REFERENCE SIGN LIST

1 power steering apparatus (in-vehicle apparatus)
4 gear housing (housing)
8 first housing member
8a first bolt insertion hole (first coupling member insertion hole)
9 second housing member
9a second bolt insertion hole (second coupling member insertion hole)
10 bolt/nut (coupling member)
11 first joint surface
12 first inner surface
13 first outer surface
14 second joint surface
15 second inner surface
16 second outer surface
17 liquid sealant
18 first sealant holding portion
18a bottom surface
18b side wall
19 second sealant holding portion
20 dimensional adjustment portion
21 bent portion

1. A housing for an in-vehicle apparatus, the housing comprising:
a first housing member including a first joint surface, a first inner surface provided on one side with respect to the first joint surface, and a first outer surface on an opposite side of the first joint surface from the first inner surface; and
a second housing member including a second joint surface, a second inner surface, and a second outer surface,
wherein the first housing member and the second housing member are coupled with each other with the first joint surface and the second joint surface in abutment with each other on the second joint surface,
wherein the second inner surface is provided on the same side as the first inner surface with respect to the second joint surface with the first joint surface and the second joint surface in abutment with each other,
wherein the second outer surface is provided on the same side as the first outer surface with respect to the second joint surface with the first joint surface and the second joint surface in abutment with each other,
wherein the second housing member forms a space facing the first inner surface and the second inner surface together with the first housing member with the first joint surface and the second joint surface in abutment with each other,
wherein the housing further includes
a first sealant holding portion,
a second sealant holding portion, and
a liquid sealant provided in the first sealant holding portion and the second sealant holding portion,
wherein the first sealant holding portion is a recessed groove opened to one of the first joint surface and the second joint surface,
wherein the first sealant holding portion is disposed at an intermediate portion in a thickness direction of the first housing member,
wherein the second sealant holding portion is a recessed portion opened to the first joint surface, the second sealant holding portion being disposed on the first inner surface side with respect to the first sealant holding portion in the thickness direction of the first housing member, the second sealant holding portion forming a recessed portion for holding the sealant between the second sealant holding portion and the second joint surface with the first joint surface and the second joint surface in abutment with each other, and
wherein the thickness direction of the first housing member is a direction extending from the first inner surface toward the first outer surface on the first joint surface.

2. The housing for the in-vehicle apparatus according to claim 1, wherein the second sealant holding portion is provided at an end portion on the same side as the first inner surface in the thickness direction of the first housing member.

3. The housing for the in-vehicle apparatus according to claim 2, wherein the second sealant holding portion has such an inclined shape that a dimension of the first housing member in the thickness direction of the first housing member gradually reduces from an end portion of the second sealant holding portion on an opposite side from the second housing member toward an end portion of the second sealant holding portion on the same side as the second housing member in a direction perpendicular to the first joint surface.

4. The housing for the in-vehicle apparatus according to claim 3, wherein the first housing member includes a dimensional adjustment portion,
wherein the dimensional adjustment portion is provided on the same side as the second housing member with respect to the second sealant holding portion in the direction perpendicular to the first joint surface,
wherein an end portion of the dimensional adjustment portion on the same side as the first inner surface in the thickness direction of the first housing member is located at the same position as an end portion of the second sealant holding portion on the same side as the second housing member or on the same side as the first, outer surface with respect to this end portion,
wherein the first joint surface is provided on an end portion on the same side as the first housing member in the direction perpendicular to the first joint surface, and
wherein the first joint surface has a machined surface cut by machining.

5. The housing for the in-vehicle apparatus according to claim 4, wherein the first housing member includes a bent portion between the second sealant holding portion and the dimensional adjustment portion in the direction perpendicular to the first joint surface.

6. The housing for the in-vehicle apparatus according to claim 3, wherein the first sealant holding portion is provided at a central portion in a region not including the second sealant holding portion or on the first inner surface side with respect to the central portion in the thickness direction of the first housing member.

7. The housing for the in-vehicle apparatus according to claim 3, wherein the second sealant holding portion is provided in such a manner that a minor angle among angles defined between an inclined surface of the second sealant holding portion and the direction perpendicular to the first joint surface is 30 degrees or wider and narrower than 45 degrees.

8. The housing for the in-vehicle apparatus according to claim 1, wherein the first housing member and the second housing member are cast items formed by casting, and
wherein the first sealant holding portion or the second sealant holding portion has a casting surface at least on a part of a surface thereof.

9. The housing for the in-vehicle apparatus according to claim 1, wherein the first outer surface is shaped in such a manner that an end portion thereof on the same side as the second outer surface in the direction perpendicular to the first joint surface is located adjacent to an end portion of the second outer surface on the same side as the first outer surface.

10. The housing for the in-vehicle apparatus according to claim 1, wherein the first sealant holding portion includes a bottom surface facing the second joint surface in a direction perpendicular to the first joint surface, and a pair of side wall surfaces provided on both sides of the bottom surface in the thickness direction of the first housing member and facing opposite from each other, and
wherein the bottom surface has a recessed circular-arc shape opened toward the second joint surface side.

11. The housing for the in-vehicle apparatus according to claim 1, wherein an arithmetic average roughness Ra of each of the first joint surface and the second joint surface is 6.4 [μm] or lower.

12. The housing for the in-vehicle apparatus according to claim 1, wherein the first sealant holding portion is annularly continuous.

13. The housing for the in-vehicle apparatus according to claim 12, further comprising a coupling member configured to couple the first housing member and the second housing member with each other,
wherein the first housing member includes a first coupling member insertion hole penetrating through in a direction perpendicular to the first joint surface, the coupling member being inserted in the first coupling member insertion hole,
wherein the second housing member includes a second coupling member insertion hole penetrating through in the direction perpendicular to the first joint surface, the coupling member being inserted in the second coupling member insertion hole, and
wherein the first sealant holding portion is provided on the first inner surface side with respect to the first coupling member insertion hole.
